(19) United States
(12) Patent Application Publication
(10) Pub. No.: US 2026/0367703 A1
(43) Pub. Date: Nov. 19, 2026

(54) PORTABLE CONTROLLER

(71) Applicant: LG ELECTRONICS INC., Seoul (KR)

(72) Inventors: Eujin KIM, Seoul (KR); Wonseok JOO, Seoul (KR); Sungjin CHOI, Seoul (KR); Mansoo SIN, Seoul (KR); Jungyun LEE, Seoul (KR); Dongchul JIN, Seoul (KR)

(73) Assignee: LG ELECTRONICS INC., Seoul (KR)

(21) Appl. No.: 19/135,350

(22) PCT Filed: Dec. 29, 2022
(86) PCT No.: PCT/KR2022/021629

§ 371 Date: Jun. 3, 2025

(51) Int. Cl. G06F 3/01; G06F 3/0362

(52) U.S. Cl. CPC G06F 3/016; G06F 3/0362

(57) ABSTRACT

This portable controller comprises: a basic controller including a handle portion; and an expansion module detachable from the basic controller, wherein the basic controller includes: a handle portion that extends in the longitudinal direction and is gripped by a user's hand; and a manipulation body located in front of the handle portion, and the expansion module includes: a module body including a coupling portion in contact with the manipulation body; a rotary housing rotatably coupled to the module body; and a module actuator mounted on the rotary housing. The portable controller having a direction of vibration provided by the module actuator that changes when the rotary housing is rotated, can change the direction of the rotary housing of the expansion module and place the module actuator in a direction suitable for XR content, such that the usability thereof can be improved.

### TECHNICAL FIELD

The present disclosure relates to a controller for controlling an extended reality (XR) device.

### BACKGROUND

Virtual reality (VR) technology provides only computer graphic (CG) images of objects or backgrounds in the real world, augmented reality (AR) technology provides computer graphic images created virtually on real object images, and mixed reality (MR) technology is a computer graphic technology that provides virtual objects mixed and combined with the real world. The aforementioned VR, AR, and MR are collectively referred to as extended reality (XR) technology.

XR technology includes a device that provides images in the form of graphics, and a typical example is a device that is worn directly on the head, such as a head-mounted display (HMD).

The head-mounted display, which is worn on the head, allows users to use a portable handheld controller to input commands. While wired types are also available, recently, wireless portable controllers that send and receive data wirelessly have become more popular.

The portable controller goes beyond simply providing user input and provides feedback to the user through vibration. In addition, the portable controller may perform user input through gestures by detecting the movement of the user's hands (or arms) other than when the user directly manipulates buttons or wheels.

In addition, different gestures and feedback are performed depending on the content used, and the method of recognizing gestures varies depending on the type of XR device, whereby there is a problem of having to use different controllers depending on the situation.

### SUMMARY

### Technical Problem

Therefore, it is an object of the present disclosure to provide a portable controller that can easily expand and change functions.

### Technical Solutions

Provided is a portable controller including a basic controller including a handle, and an extension module detachable from the basic controller, wherein the basic controller includes the handle extending in a longitudinal direction and gripped by a user with a hand, and a manipulation body positioned in front of the handle, wherein the extension module includes a module body including a coupling portion in contact with the manipulation body, a rotatable housing rotatably coupled to the module body, and a module actuator mounted in the rotatable housing, wherein when the rotatable housing is rotated, a direction of vibration provided by the module actuator is changed.

The module actuator may be an impact actuator that provides an impact vibration in a specific direction.

The rotatable housing may be arranged in one of a first state where the module actuator provides an impact in a direction parallel to the handle of the basic controller, and a second state where the module actuator provides the impact in a direction perpendicular to the handle of the basic controller.

The portable controller may further include an angle-restricting member that restricts a rotation angle of the rotatable housing to 90°.

The angle-restricting member may include an angle-restricting protrusion protruding from a side surface of the rotatable housing, and an angle-restricting slot defined in a mounting portion of the module body where the rotatable housing is mounted, wherein the angle-restricting protrusion is inserted into the angle-restricting protrusion,
the angle-restricting protrusion may be positioned at one end of the angle-restricting slot in the first state and at an end opposite to the one end of the angle-restricting slot in the second state. The portable controller may further include a pair of fixed magnets mounted in the module body and respectively disposed on one side and a side opposite to the one side of the angle-restricting slot, and
a rotatable magnet positioned in the angle-restricting protrusion and moveable between the pair of fixed magnets.

Each of the pair of fixed magnets may have a surface facing the rotatable magnet having a pole different from a pole of the rotatable magnet.

The portable controller may further include a Hall sensor disposed adjacent to each fixed magnet, and a controller that determines the arrangement of the rotatable housing based on a magnetic force change sensed by the Hall sensor.

The basic controller may include a first connection terminal formed on the manipulation body, the extension module may include a second connection terminal formed on the coupling portion and fastened to the first connection terminal, a module board where the second connection terminal is mounted and located in the module body, a wire connecting the module board with the actuator, and a wire mounting portion defined in an upper surface of the rotatable housing, wherein the wire extends to the module board in the wire mounting portion, and the wire mounting portion may be opened toward the module board when a state of the rotatable housing changes.

The wire may include a plurality of wires, and the portable controller may further include a wire guide protruding from the wire mounting portion such that interference between the wires does not occur when the rotatable housing rotates.

The rotatable housing may include a lever exposed outward of the module body, and the rotatable housing may be rotated by rotating the lever.

The extension module may further include a motor that provides a driving force to rotate the rotatable housing.

The rotatable housing may include a cylindrical body having a first guide formed along an outer circumference thereof, and the module body may include a second guide positioned around the circumference of the rotatable housing and engaged with the first guide to guide the rotation of the rotatable housing.

The coupling portion of the module body may have a U-shape of surrounding a front side and left and right sides of the manipulation body.

### Advantageous Effects

According to at least one embodiment of the present disclosure, an extension module may be easily detachably attached to a portable controller to expand and change functions.

In addition, according to at least one embodiment of the present disclosure, the portable controller may direct the actuator in the direction suitable for the XR content by changing the direction of the rotatable housing of the extension module, thereby increasing usability.

The effects obtainable from the present disclosure are not limited by the above mentioned effects, and other unmentioned effects can be clearly understood from the above description by those having ordinary skill in the technical field to which the present disclosure pertains.

### BRIEF DESCRIPTION OF THE DRAWINGS

FIG. 1 is a perspective view showing a portable controller according to an aspect of the present disclosure.

FIG. 2 is a view showing a basic controller and an extension module of the portable controller according to the aspect of the present disclosure.

FIG. 3 is an exploded perspective view showing the basic controller of the portable controller according to the aspect of the present disclosure.

FIG. 4 is an exploded perspective view of the extension module of the portable controller according to the aspect of the present disclosure.

FIG. 5 is a view showing an example of content used in an XR device.

FIG. 6 is a view showing a first state and a second state of a rotatable housing of a portable controller according to an aspect of the present disclosure.

FIG. 7 is a bottom view of a portable controller according to an aspect of the present disclosure.

FIG. 8 is a cross-section taken along a line A-A in FIG. 7.

FIG. 9 is a view showing an embodiment of a driver of a portable controller according to an aspect of the present disclosure.

FIG. 10 is a view showing an embodiment of arrangement of wires of a rotatable portion of a portable controller according to an aspect of the present disclosure.

FIG. 11 is a view showing another embodiment of an arrangement of a wire of a rotatable portion of a portable controller according to an aspect of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

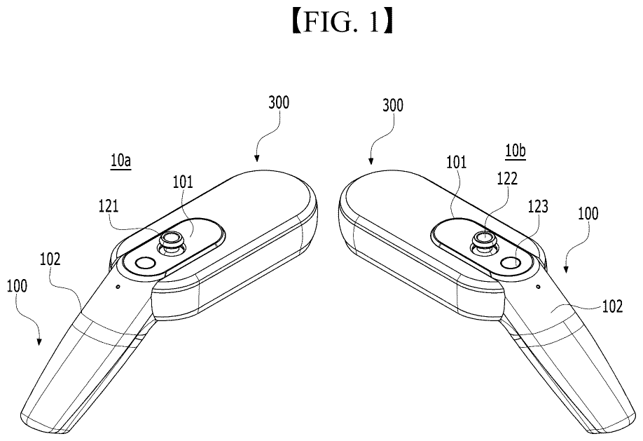

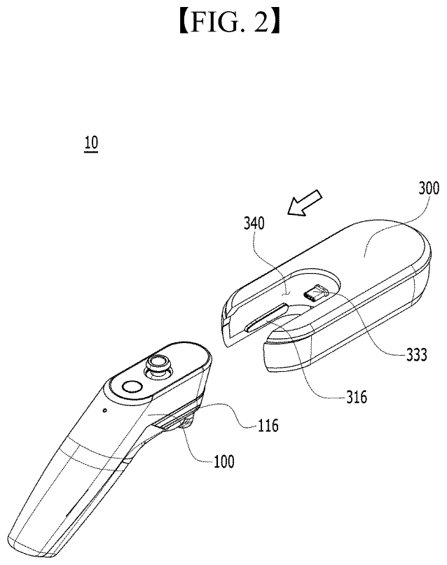

FIG. 1 is a perspective view showing a portable controller 10 according to an aspect of the present disclosure, and FIG. 2 is a view showing a basic controller and an extension module of the portable controller according to the aspect of the present disclosure.

XR technology may include an XR device that provides images in the form of graphics. The XR device may use a screen that is located in front of or around a user, and a device that is worn directly on the head, such as a head-mounted display (HMD), may be used as a representative XR device.

The XR device requires a portable controller 10 that users hold in their hand to input commands in order to immersively use the device while moving around.

The controller 10 of the present disclosure may include a handle portion 102 that is grasped by hand and a manipulation body 101 located in front of the handle portion 102. The handle portion 102 may be grasped by the palm at the bottom of the thumb, the middle finger, the ring finger, and the little finger, and buttons located on the manipulation body 101 may be manipulated using the index finger and the thumb.

The thumb may be used to manipulate a function key 123 and a trackball 121 or a joystick 122 located at an upper part of the manipulation body 101, and the index finger may be used to manipulate a trigger button 125 located at the front of the manipulation body 101.

A pair of controllers 10a and 10b may be configured as a set such that the user can hold and use the same in their left and right hands, respectively. The pair of controllers 10a and 10b may have the same buttons, but may be configured to allow various manipulations through different buttons.

For example, according to the embodiment shown in FIG. 1, the left side may include an input portion 121, 122, 123, and 125 in the form of a joystick 122, and the right side may include an input portion in the form of a trackball 121. The joystick 122 is advantageous for two-dimensional movement, and the trackball 121 may be used for rotation and gaze movement.

The number of portable controllers 10 required may vary depending on the application in use. In the case of an application with simple manipulation, only one basic controller 100 may be required to control the same, but in the case of applications requiring a variety of controls, it may be necessary to hold controllers in both hands.

When using an application that moves the gaze and explores the space, both the joystick 122 and the trackball 121 are required, whereby the portable controller 10a and 10b must be held in both hands. Either one or both of the controllers 10a and 10b may be used as needed.

The portable controller 10 may detect the user's gestures and recognize the same as user input, going beyond simply manipulating a cursor or a pointer on the screen.

The user's gestures may vary depending on the application that is used. For example, when using a sports application, user's movements may be detected through the portable controller 10. The functions required of the portable controller 10 may vary depending on how the XR device detects the user's gestures and the position of sensors of the XR device.

Conventionally, the user's gesture is detected based on the change in the position of the portable controller 10 using a position sensor, such as a gyro sensor, of the portable controller 10.

However, in the case of XR applications, it is necessary to detect more sophisticated user movements. In order to detect not only large gestures such as arm movements, but also small gestures such as bending the wrist and rotating the wrist, a method of externally tracking the movement of the controller may be used.

In addition, the portable controller 10 may function as an output that provides the user with tactile feedback, which is more than just sight and hearing, in addition to receiving user commands.

Tactile feedback provides a different sense depending on the direction, speed, and magnitude of vibration, in addition to vibration that oscillates in one direction. An actuator 141 that provides rich tactile feedback requires a plurality of actuators to provide various sensations.

However, in order to have the various input and output functions described above, the size of the portable controller 10 increases.

Accordingly, the portable controller 10 of the present disclosure may include a basic controller 100 and an extension module 300 detachably attached to the basic controller 100, as shown in FIG. 2.

Basic functions may be used with the basic controller 100 alone, but the extension module 300 with specialized functions for more precise control and to provide various sensations may be added to the basic controller 100.

The extension module 300 has a shape that can be inserted from the front of the basic controller 100, as shown in FIG. 2. The extension module may be coupled at the front of the manipulation body 101 so as not to interfere with the handle portion 102 extending in a direction toward the rear surface of the manipulation body 101.

In the coupled state shown in FIG. 1, functions installed in the extension module 300 may be additionally utilized. The extension module 300 of the present embodiment includes a ring case (an LED marker ring) 220, in which an LED marker 224 that can track the user's gestures is disposed.

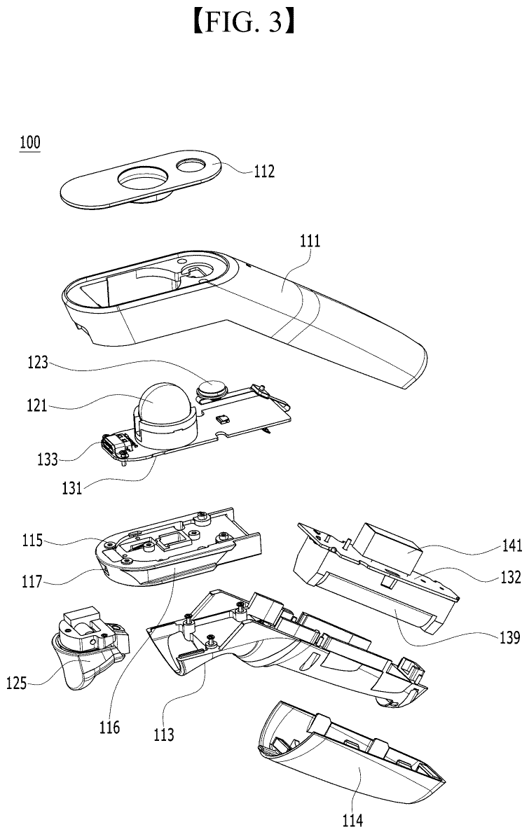

The extension module 300 includes a module body 210 that includes a U-shaped coupling portion 240 that wraps around front and side surfaces of the manipulation body 101. The module body 210 may be equipped with a module for additional functions inside, for example, an additional button as shown in FIG. 3. The module body 210 may be deformed into various shapes according to the function of the extension module 300.

A coupling rail is provided to ensure that the basic controller 100 and the extension module 300 are stably fastened to each other, and a second connector 233 configured to electrically connect the extension module 300 and the basic controller 100 to utilize the functions of the extension module 300 may be provided. The connector and the coupling rail may be located on the side perimeter of the manipulation body 101 where the basic controller 100 and the extension module 300 are in contact with each other and at the coupling portion 240 of the extension module 300.

FIG. 3 is an exploded perspective view showing the basic controller 100 of the portable controller 10 according to the aspect of the present disclosure.

The basic controller 100 includes a case 111, 112, 113, 114, and 115 forming the external shape thereof, and the case may be configured separately from the handle portion 102 and the manipulation body 101, but the present embodiment may ensure the assembly of parts through the case 111 and 112 coupled in a vertical direction.

The manipulation body 101 includes a trigger button 125, function keys, and a trackball 121 mounted on a main board 131. The handle portion 102 may include a battery 139 and a basic actuator 141 that transmits vibration, and may be mounted on an auxiliary board 132 and connected to the main board 131 to detect user input.

The case 111, 112, 113, and 114 is made of an injection molded material for ease of manufacturing, but the middle frame 115 that is partially rigid may be equipped for durability. The middle frame 115 is located under the main board 131 of the manipulation body 101 and may support a rear surface of the input portion when the input portion is pressed. The trigger button 125 is also coupled to the middle frame 115, and the frame may support the force of the trigger button 125 by pressing the button in a direction toward the frame.

A top cover 112 with an opening may be coupled to an upper surface of the manipulation body 101 such that the user input portion is exposed. A lower part of the handle portion 102 may further include a bottom cover 114 made of a different material to improve the grip. The top cover 112 and the bottom cover 114 may be omitted.

The basic controller 100 may be configured to be symmetrical to the left and right so as to be used without distinction between the left and right hands. When using a pair of basic controllers 100, a basic controller 100 with a trackball 121 and a basic controller 100 with a joystick 122 may be used, and since they are symmetrical, the left and right sides may be arbitrarily set and changed by the user.

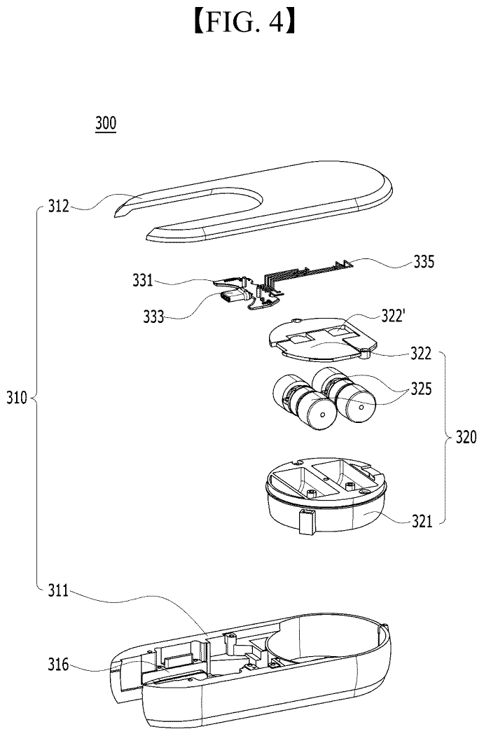

FIG. 4 is an exploded perspective view of the extension module 300 of the portable controller 10 according to the aspect of the present disclosure. The extension module 300 of the present embodiment has a module actuator 325 that provides the tactile feedback to the user, thereby enhancing a sense of presence in augmented reality or virtual reality.

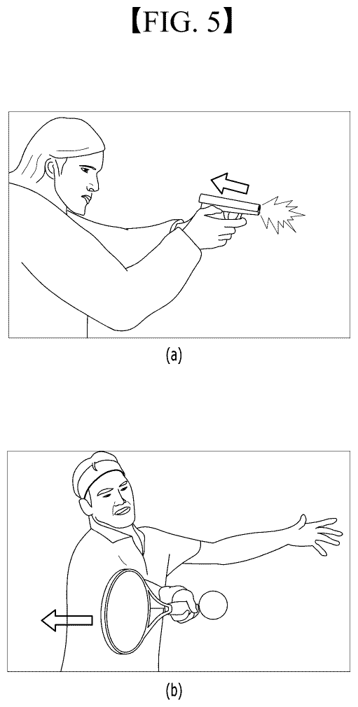

FIG. 5 is a view showing an example of content used in an XR device. (a) in FIG. 5 shows a shooting scene and (b) shows a sports scene of hitting a ball with a racket, such as tennis. The scene in FIG. 5 may be a scene from game content, but the content of the XR device may also include simulation content such that training is available even not in a real-world environment.

In the case of simulation, a more realistic sensation should be provided. In addition to a visual or auditory sense, a tactile sense is also an important element in the sense of presence. In the case of using the content of shooting a gun, as in (a) in FIG. 5, there should be a recoil when pressing the trigger button 125 like when shooting an actual gun to obtain an effect similar to reality.

As in (b) in FIG. 5, there should be a striking sensation when the ball hits the racket so that the user is able to sense whether the ball has touched the racket.

The basic controller 100 also includes the actuator 141 that provides vibration, but the basic actuator 141 of the basic controller 100 is an actuator of a non-directional type, making it difficult to provide the striking sensation of providing a strong impact in a specific direction.

When using XR content that requires the striking sensation, the extension module 300 equipped with an impact actuator 325, which is an actuator that provides a great force in a specific direction, may be coupled to the basic controller 100 to enhance a sense of presence of the XR content.

However, there is a problem that the striking sensation in (a) in FIG. 5 and the striking sensation in (b) in FIG. 5 have different directions and thus require different extension modules 300. Accordingly, the present disclosure provides the portable controller 10 that includes the extension module 300 that may change an impact direction of the impact actuator 325.

The extension module 300 of the present disclosure includes a module body 310 and a rotatable portion 320 rotatably coupled to the module body 310. The rotatable portion 320 is composed of a cylindrical rotatable housing 321 and the module actuator 325 mounted in the housing. The direction of the module actuator 325 may be changed by rotating the rotatable housing 321.

The module body 310 is composed of a lower casing 311 with an open upper portion and an upper cover 312 covering the lower casing 311, and the rotatable housing 321 is inserted into the lower casing 311 from above. The module body 310 may include a U-shaped concave portion as a coupling portion 340 for coupling with the manipulation body 101 of the basic controller 100. A second coupling rail 316 that is fastened to a first coupling rail 116 of the basic controller 100 may be located in the coupling portion 340 of the lower casing 311.

The rotatable housing 321 may have a cylindrical shape for easy rotation, and may have different cross-sectional areas of upper and lower portions, but may have a circular horizontal cross-section for the rotation. The rotatable housing 321 of the present embodiment is coupled to the module body 310 in a downward direction, so that the lower portion of the rotating housing 321 may be slightly smaller than the upper portion.

The module actuator 325 mounted in the rotatable housing 321 may apply the impact in the specific direction. To provide a greater impact, a plurality of module actuators 325 may be equipped, and the plurality of module actuators 325 may be arranged in the same direction.

A rotatable portion cover 322 covering an upper surface of the module actuator 325 may be further included in the rotatable housing 321, and the rotatable portion cover 322 may have an opening 322′ defined therein to connect the module actuator 325 with a wire 335.

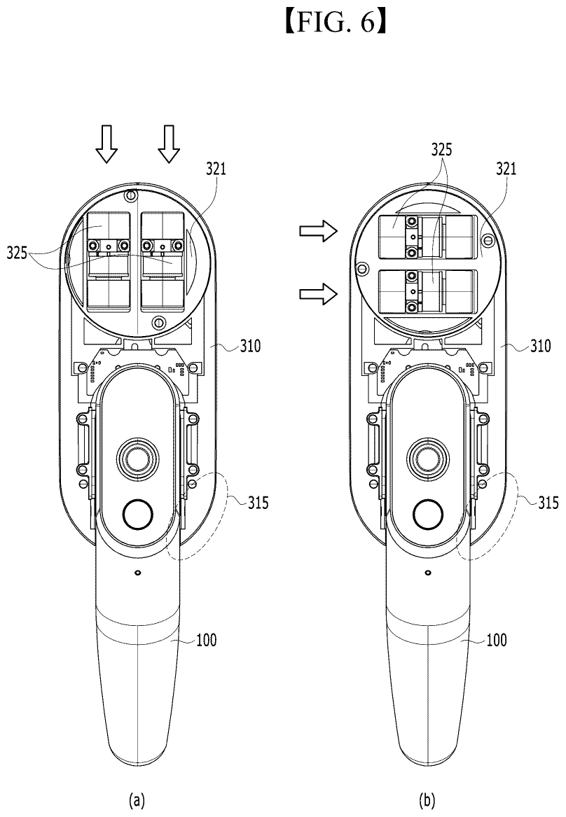

FIG. 6 is a view showing a first state and a second state of the rotatable housing 321 of the portable controller 10 according to an aspect of the present disclosure. In the first state in which the rotatable housing 321 is directed as in (a) in FIG. 6, the impact may be transmitted in a direction parallel to an extension direction of the handle portion 102, thereby providing the impact in a front and rear direction as in (a) in FIG. 5.

The module actuator 325 may be directed in a state as in (b) by rotating the rotatable housing 321 by 90°. In the second state in which the module actuator 325 is directed in a horizontal direction as in (b) in FIG. 6, the impact direction becomes vertical to the handle. As in (b) in FIG. 5, the striking sensation of the ball hitting the racket or a bat may be provided.

The impact of the module actuator 325 is transmitted to the module body 310 via the rotatable housing 321. When the user grips the portable controller 10, a user's hand may touch a dotted line portion 315 in FIG. 6 and thus receive the impact of the module actuator 325. Alternatively, the impact of the module body 310 may be transmitted to the basic controller 100 and thus the impact may be sensed by the user's hand gripping the handle portion 102.

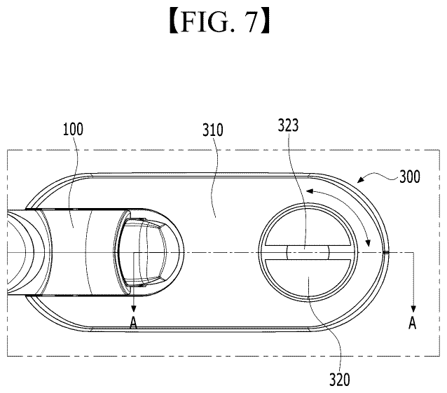

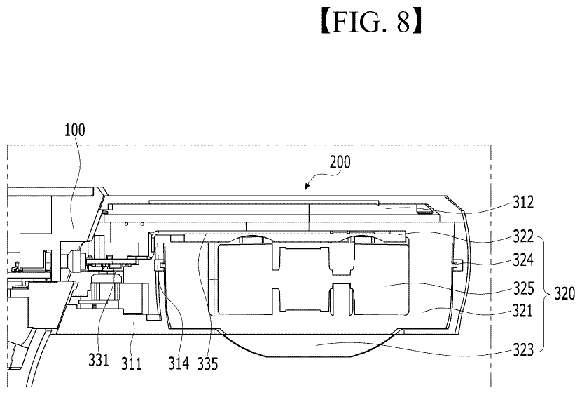

FIG. 7 is a bottom view of the portable controller 10 according to an aspect of the present disclosure, and FIG. 8 is a cross-section taken along a line A-A in FIG. 7. The module housing 300 of the present embodiment may have a lever 323 exposed outward of the module body 310 such that the rotatable housing 321 may be rotated manually.

The controller of the present embodiment may have the lever 323 protruding from a lower surface of the module body 310, and the user may grip and rotate the lever 323 to change the direction of the module actuator 325. The lever 323 may have an elongated shape in one direction and may be rotated as both sides in a direction perpendicular to a longitudinal direction are gripped with the hand.

To intuitively recognize the impact direction, the longitudinal direction of the lever 323 may be the same as a direction corresponding to the impact direction, that is, the direction in which the module actuator 325 is oriented.

Referring to FIG. 8, the rotatable housing 321 may have a guide structure so as to rotate without shaking in a vertical direction during the rotation. A first guide 324 formed around the rotatable housing 321 and a second guide 314 formed around an inner circumference of a mounting portion where the rotatable housing 321 is mounted of the module body 310 are engaged with each other. They may be formed at one side using a POM (polyacetal, poly oxy methylene) material so as to reduce friction.

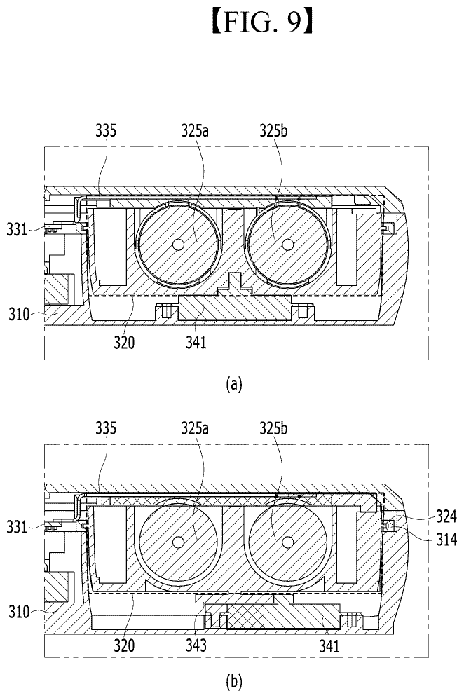

FIG. 9 is a view showing an embodiment of a driver of the portable controller 10 according to an aspect of the present disclosure. The rotatable housing 321 of the present embodiment may be of an automatically rotatable type and include a motor 341. The motor 341 may be connected in series with the rotatable housing 321 as shown in (a) in FIG. 9. In this case, gears should be arranged inside a motor module 341 such that the motor 341 and the rotatable housing 321 are directly coupled to each other, so that a vertical length of the motor 341 may be increased.

As in (b), a gear 343 for power transmission may be additionally disposed. In this case, a degree of freedom in a placement of the motor is high, but as the number of gears 343 increases, an ease of assembly is not as good as that in the embodiment of (a).

In the case of including the motor 341, the user may rotate the rotatable housing 321 using a button without having to manually rotate the same.

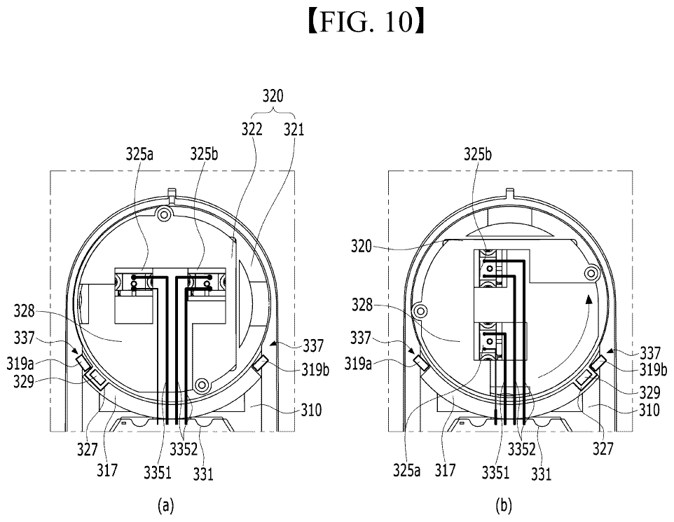

FIG. 10 is a view showing an embodiment of arrangement of wires 3351 and 3352 of the rotatable portion 320 of the portable controller 10 according to an aspect of the present disclosure. The rotatable housing 321 should be restricted to move between the first state and the second state as shown in (a) and (b) in FIG. 6, and a component that fixes the rotatable housing 321 to maintain the first state and the second state is required. An angle-restricting member 317 and 327 that restricts a rotation angle of the rotatable housing 321 and a stopper magnet 319a, 319b, and 329 that fixes the rotatable housing 321 may be included.

The angle-restricting member 317 and 327 may include an angle-restricting protrusion 327 protruding from a side surface of the rotatable housing 321, and an angle-restricting slot 317 defined in the mounting portion where the rotatable body is mounted and into which the angle-restricting protrusion 327 is inserted.

The angle-restricting protrusion 327 is located at one end of the angle-restricting slot 317 in the first state and at the other end of the angle-restricting slot 317 in the second state. The angle-restricting protrusion 327 and the angle-restricting slot 317 restrict the rotatable housing 321 to rotate only between the two states, without rotating more clockwise in the first state or more counterclockwise in the second state.

The stopper magnet may include fixed magnets 319a and 319b located in the module body 310 and a rotatable magnet 329 located in the rotatable housing. A pair of fixed magnets 319a and 319b are located on one side and the other side of the angle-restricting slot 317.

The rotatable magnet 329 is located in the angle-restricting protrusion 327, moves between the pair of fixed magnets 319a and 319b, and is magnetically attached to the fixed magnets 319a and 319b when placed adjacent to them.

The rotatable magnet 329 may have poles thereof arranged in a rotation direction, and may include a first pole (an S pole in the drawing) attached to a fixed magnet 319a located on one side, and a second pole (an N pole in the drawing) attached to a fixed magnet 319b located on the other side.

Accordingly, the fixed magnet 319a located on one side may be directed such that a second pole (an N pole in the drawing) thereof faces the rotatable magnet 329, and the fixed magnet 319b located on the other side may be directed such that a first pole (an S pole in the drawing) thereof faces the rotatable magnet 329. In other words, the poles of the three magnets may be arranged in parallel in the rotation direction.

In the drawing, the first pole is illustrated as the S pole and the second pole is illustrated as the N pole, but an arrangement in a reverse direction is also available.

A Hall sensor 337 positioned adjacent to the fixed magnet 319a and 319b may sense a change in a magnetic field that changes when the rotatable magnet 329 approaches, determine a location of the rotatable module, and transmit the location to the basic controller 100.

To supply power to and control the module actuator 325, the module actuator 325 may be connected to a module board 331 via the wires 3351 and 3352. Because a rotation angle of the rotatable housing 321 is restricted as described above, entanglement of the wires 3351 and 3352 resulted from a plurality of rotations of the rotatable housing 321 does not occur. However, a length between a terminal of the module actuator 325 and the module board 331 may vary in the first state and the second state.

A pair of module actuators 325 may have similar lengths of the wires 3351 and 3352 required in the first state, but the lengths of the wires 3351 and 3352 may vary in the second state because distances between the pair of module actuators 325 and the module board are different.

(a) in FIG. 10 shows an optimal arrangement of the wires 3351 and 3352 in the first state, and (b) in FIG. 10 shows an optimal arrangement of the wires 3351 and 3352 in the second state. The wires 3351 and 3352 may interfere with the rotatable portion 320 when the rotatable portion 320 rotates and switches the state thereof between the first state and the second state.

To prevent the interference between the wires 3351 and 3352 and the rotatable portion 320, a wire mounting portion 328 formed with a low height in an upper surface of the rotatable portion 320, i.e., the rotatable portion cover 322, may be included.

The wire mounting portion 328 may have a fan shape and may have an angle of about 90° such that the wires 3351 and 3352 may extend toward the module board 331 in both the first state and the second state.

A first wire 3351 connected to a first module actuator 325a located at a rear side (a lower side in the drawing) in the second state requires a smaller length in the second state than in the first state, and a second wire 3352 connected to a second module actuator 325b located at a front side requires a greater length in the second state than in the first state.

Therefore, the first wire 3351 may use a wire 3351 of a length corresponding to an optimal length (48.3 mm and 53.8 mm in the drawing) in the first state, and the second wire 3352 may use a wire 3352 of a length corresponding to an optimal length (61.2mm and 54.7 mm in the drawing) in the second state.

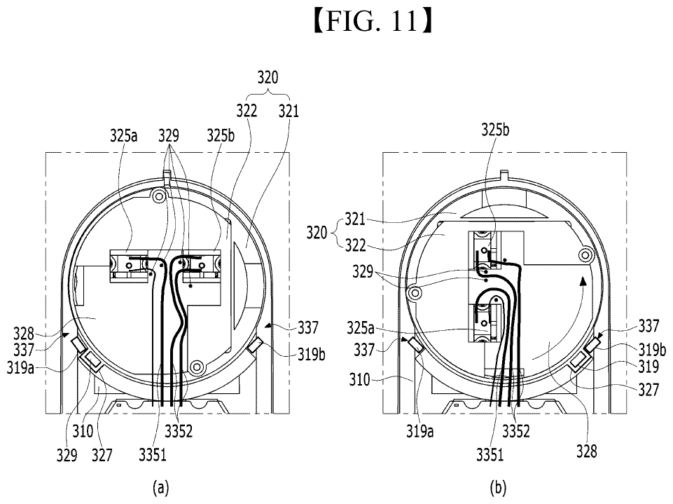

FIG. 11 is a view showing another embodiment of the arrangement of the wire 335 of the rotatable portion 320 of the portable controller 10 according to an aspect of the present disclosure. Because the length of the first wire 3351 in FIG. 11 is determined based on the length in the first state, the first wire 3351 may be loosely disposed with slack in the second state.

Because the wires 3351 and 3352 may overlap each other and become entangled together, a wire guide 329 protruding from the wire mounting portion 328 may be included as in (b) in FIG. 11 to maintain tension even in the second state.

As in (b) in FIG. 11, the slack of the first wire 3351 in the second state may be managed via the wire guide 329, thereby preventing the interference between the wires 3351 and 3352.

The wire guide 329 is intended to prevent the interference between the wires 3351 and 3352, so that the wire guide 329 may protrude between the plurality of wires 3351 and 3352.

As seen above, according to at least one embodiment of the present disclosure, the extension module 300 may be easily attached to/detached from the portable controller 10 to expand and change functions.

In addition, according to at least one embodiment of the present disclosure, the single extension module 300 of the portable controller 10 may change the direction of the rotatable housing 321 to direct the module actuator 325 in the direction suitable for the XR content, thereby increasing usability.

The above detailed description should not be construed as being limitative in all terms, but should be considered as being illustrative. The scope of the present disclosure should be determined by reasonable analysis of the accompanying claims, and all changes in the equivalent range of the present disclosure are included in the scope of the present disclosure.

What is claimed is:

1. A portable controller comprising:
a basic controller including a handle; and
an extension module detachable from the basic controller,
wherein the basic controller includes:
the handle extending in a longitudinal direction and gripped by a user with a hand; and
a manipulation body positioned in front of the handle,
wherein the extension module includes:
a module body including a coupling portion in contact with the manipulation body;
a rotatable housing rotatably coupled to the module body; and
a module actuator mounted in the rotatable housing,
wherein when the rotatable housing is rotated, a direction of vibration provided by the module actuator is changed.

2. The portable controller of claim 1, wherein the module actuator is an impact actuator configured to provide an impact vibration in a specific direction.

3. The portable controller of claim 1, wherein the rotatable housing is arranged in one of a first state where the module actuator provides an impact in a direction parallel to the handle of the basic controller, and a second state where the module actuator provides the impact in a direction perpendicular to the handle of the basic controller.

4. The portable controller of claim 3, further comprising an angle-restricting member configured to restrict a rotation angle of the rotatable housing to 90°.

5. The portable controller of claim 4, wherein the angle-restricting member includes:
an angle-restricting protrusion protruding from a side surface of the rotatable housing; and
an angle-restricting slot defined in a mounting portion of the module body where the rotatable housing is mounted, wherein the angle-restricting protrusion is inserted into the angle-restricting protrusion,
wherein the angle-restricting protrusion is positioned at one end of the angle-restricting slot in the first state and at an end opposite to the one end of the angle-restricting slot in the second state.

6. The portable controller of claim 5, further comprising:
a pair of fixed magnets mounted in the module body and respectively disposed on one side and a side opposite to the one side of the angle-restricting slot; and
a rotatable magnet positioned in the angle-restricting protrusion and moveable between the pair of fixed magnets.

7. The portable controller of claim 6, wherein each of the pair of fixed magnets has a surface facing the rotatable magnet having a pole different from a pole of the rotatable magnet.

8. The portable controller of claim 6, further comprising:
a Hall sensor disposed adjacent to each fixed magnet; and
a controller configured to determine the arrangement of the rotatable housing based on a magnetic force change sensed by the Hall sensor.

9. The portable controller of claim 1, wherein the basic controller includes a first connection terminal formed on the manipulation body,
wherein the extension module includes:
a second connection terminal formed on the coupling portion and fastened to the first connection terminal;
a module board where the second connection terminal is mounted and located in the module body;
a wire connecting the module board with the actuator; and
a wire mounting portion defined in an upper surface of the rotatable housing,
wherein the wire extends to the module board in the wire mounting portion,
wherein the wire mounting portion is opened toward the module board when a state of the rotatable housing changes.

10. The portable controller of claim 9, wherein the wire includes a plurality of wires,
wherein the portable controller further includes a wire guide protruding from the wire mounting portion such that interference between the wires does not occur when the rotatable housing rotates.

11. The portable controller of claim 1, wherein the rotatable housing includes a lever exposed outward of the module body,
wherein the rotatable housing is rotated by rotating the lever.

12. The portable controller of claim 1, wherein the extension module further includes a motor configured to provide a driving force to rotate the rotatable housing.

13. The portable controller of claim 1, wherein the rotatable housing includes a cylindrical body having a first guide formed along an outer circumference thereof,
wherein the module body includes a second guide positioned around the circumference of the rotatable housing and engaged with the first guide to guide the rotation of the rotatable housing.

14. The portable controller of claim 1, wherein the coupling portion of the module body has a U-shape of surrounding a front side and left and right sides of the manipulation body.
